(19) United States
(12) Patent Application Publication
(10) Pub. No.: US 2017/0370290 A1
(43) Pub. Date: Dec. 28, 2017

(54) GAS TURBINE ENGINE

(71) Applicant: ROLLS-ROYCE plc, London (GB)

(72) Inventor: Stephen J BRADBROOK, Clevedon (GB)

(73) Assignee: ROLLS-ROYCE plc, London (GB)

(21) Appl. No.: 15/604,999

(22) Filed: May 25, 2017

(30) Foreign Application Priority Data
Jun. 22, 2016 (GB) 1610879.7

(51) Int. Cl. F02C 7/143; F02C 3/04; F02K 3/06; F02K 3/115

(52) U.S. Cl. CPC F02C 7/143; F02K 3/06; F02C 3/04; F02K 3/115; F05D 2260/205; F05D 2260/211; F05D 2220/323

(57) ABSTRACT

An aircraft gas turbine engine includes a fan arranged to be driven by a gas turbine engine core. The core includes a first core module including a first compressor and a fan drive turbine interconnected by a first shaft, and a second core module including a second compressor and a second turbine interconnected by a second shaft, the first and second core modules being axially spaced. The gas turbine engine further includes an intercooler arrangement configured to cool core airflow between the first and second compressors, the intercooler arrangement including a cooling air duct provided in heat exchange relationship with a compressor duct provided between the first and second compressors, the cooling air duct including a fan air inlet configured to ingest fan air downstream of the fan, wherein the cooling air duct includes a flow modulation valve configured to modulate air mass flow through the fan air inlet.

### FIELD OF THE INVENTION

The present invention relates to a gas turbine engine, particularly to a gas turbine engine suitable for use on an aircraft, and an aircraft comprising a gas turbine engine.

### BACKGROUND TO THE INVENTION

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 24. A nacelle 21 generally surrounds the engine 10 and defines both the intake 12 and a bypass exhaust nozzle 20.

The gas turbine engine 10 works in the conventional manner so that air entering the intake 12 is accelerated by the fan 13 to produce two air flows: a first air flow A into the intermediate pressure compressor 14 and a second air flow B which passes through a bypass duct defined by an internal space between a radially inner side of the engine nacelle 21 and a radially outer side of a core nacelle 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 24 to provide additional propulsive thrust. The high 17, intermediate 18 and low 19 pressure turbines drive respectively the high pressure compressor 15, intermediate pressure compressor 14 and fan 13, each by suitable interconnecting shafts. The compressors 14, 15, combustor 16 and turbines 17, 18, 19 define an engine core, and are housed within the core nacelle 22. The core nacelle 22 defines a core inlet 23 at an axially forward end, and a core exhaust 24 at an axially rearward end.

A figure of merit for gas turbine engines is the “bypass ratio”, i.e. the ratio of air mass flow which bypasses the core, relative to the mass flow which flows through the core. In general, at subsonic and transonic speeds, higher bypass ratios result in higher propulsive efficiency, and therefore lower specific fuel consumption. However, as the bypass ratio increases, the fan pressure ratio necessarily decreases. Low pressure ratio fans are particularly susceptible to operability issues such as stall and/or flutter during some operational conditions. Consequently, it has been proposed to provide such fan with one or both of variable pitch, and a variable area nozzle. In both cases, these devices can be used to adjust the pressure ratio on the fan, and so prevent stall and/or flutter. However, these devices are relatively heavy and expensive, and do not generally contribute to the performance of the engine in themselves, and so represent dead weight.

It is also desirable to increase the thermal efficiency of the gas turbine engine. It is known to provide one or both of intercooling and recuperation to increase the thermal efficiency. Intercooling arrangements comprise a heat exchanger having a hot side in thermal contact with compressed air, upstream of further compression stages, and a cold side in thermal contact with a cold sink such as bypass flow. For example, the hot side may be located between an outlet of a booster or intermediate pressure compressor, and an inlet of a high pressure compressor. By reducing the temperature of the compressed air prior to further compression, the work required to compress the air further is reduced. Similarly, a recuperator arrangement comprises a heat exchanger having a hot side in thermal contact with an area downstream of the engine combustor (such as downstream of the final turbine stage), and a cold side in thermal contact with a combustor inlet. Consequently, waste heat is recycled into the engine, thereby increasing thermal efficiency. However, such systems add weight and complexity to engines, and are difficult to package in the limited space available.

The present invention seeks to provide an aircraft gas turbine engine which overcomes or ameliorates some or all of the above problems.

### SUMMARY OF THE INVENTION

According to a first aspect of the present invention, there is provided an aircraft gas turbine engine comprising:

a fan arranged to be driven by a gas turbine engine core, the core comprising a first core module comprising a first compressor and a fan drive turbine interconnected by a first shaft, and a second core module comprising a second compressor and a second turbine interconnected by a second shaft, the first and second core modules being axially spaced;

an intercooler arrangement configured to cool core airflow between the first and second compressors, the intercooler arrangement comprising a cooling air duct provided in heat exchange relationship with a compressor duct provided between the first and second compressors, the cooling air duct comprising a fan air inlet configured to ingest fan air, downstream of the fan, wherein the cooling air duct comprises a flow modulation valve configured to modulate air mass flow through the fan air inlet.

Advantageously, such an arrangement provides a compact gas turbine engine, in which intercooling is provided to improve thermodynamic by enabling a higher overall pressure ratio while maintaining an acceptable compressor delivery air temperature. Meanwhile, the intercooler flow modulation valve provides control over intercooling, whilst simultaneously controlling effective fan outlet area using the same valve, since the intercooler cooling duct inlet is provided downstream of the fan. Consequently, fan pressure ratio can be controlled, thereby preventing fan flutter, whilst also controlling the temperature of air delivered to the high pressure compressor. It has been found that at high engine thrust settings at low altitude (for example at takeoff), high intercooling (i.e. a large reduction in compressor air temperature) is required, to control high pressure compressor delivery temperatures. Simultaneously, high fan outlet areas are required to control fan operability (stall and flutter). Consequently, the same valve setting can beneficially affect both parameters. On the other hand, at high altitude, lower thrust conditions, intercooling can be reduced, since lower atmospheric temperature allows higher compressor pressure rise without resulting in higher compressor delivery temperatures, whereas a reduced fan outlet area may increase fan efficiency. Consequently, core temperature control and fan efficiency can be advantageously controlled using a single actuator.

The core may comprise a compressor provided axially rearwardly of the fan drive turbine.

The fan drive coupling may comprise a gearbox arranged such that the fan drive turbine rotates at a higher rotational speed than the fan in use. The gearbox may have an input:output ratio of between 1 and 5, and preferably has a ratio greater than 2. It is has been found that the present invention is particularly advantageous where the gearbox comprises a reduction gearbox. Reduction gearboxes permit relatively high speed fan drive turbines to be employed, which increases the efficiency of the turbine, while reducing the number of turbine stages that are required, and reducing the diameter of the turbine, thereby reducing the weight and cost of the fan drive turbine. Consequently, the input shaft which interconnects the fan drive turbine and gearbox rotates at a relatively high speed. As a result, the torque carried by the input shaft is relatively low for a given power. This in turn means that a relatively thin, low diameter input shaft relative to the diameter of the core can be employed. Such shafts reduce weight further, but may result in bending or “whirl” modes of vibration. By employing a turbine engine core in which the fan drive turbine is provided as part of a second core module which is axially spaced from a first core module, the fan drive input shaft length is reduced, thereby ameliorating this issue.

The engine core may comprise a low pressure compressor, which may comprise either the first or the second compressor. The low pressure compressor may be coupled to the fan drive turbine by a low pressure shaft. The engine core may further comprise a high pressure turbine which may be coupled to a high pressure compressor by a high pressure shaft, which is independently rotatable relative to the low pressure shaft. The high pressure compressor may comprise one or more axial compressor stages upstream in core flow of one or more centrifugal compressor stages. The high pressure turbine may comprise a two-stage turbine.

The low pressure compressor may be provided axially forwardly of the low pressure turbine, and may be provided axially forwardly of the gearbox.

The gas turbine engine may comprise an exhaust duct configured to redirect forward flowing exhaust air from the fan drive turbine to a rearward direction.

According to a second aspect of the present invention there is provided an aircraft comprising a gas turbine engine in accordance with the first aspect of the invention.

### BRIEF DESCRIPTION OF THE DRAWINGS

FIG. 1 shows a prior gas turbine engine;

FIG. 2 shows a schematic cross sectional side view of a first gas turbine engine in accordance with the present disclosure; and

FIG. 3a and FIG. 3b show a close-up of the part of the component of FIG. 2 shown in box D;

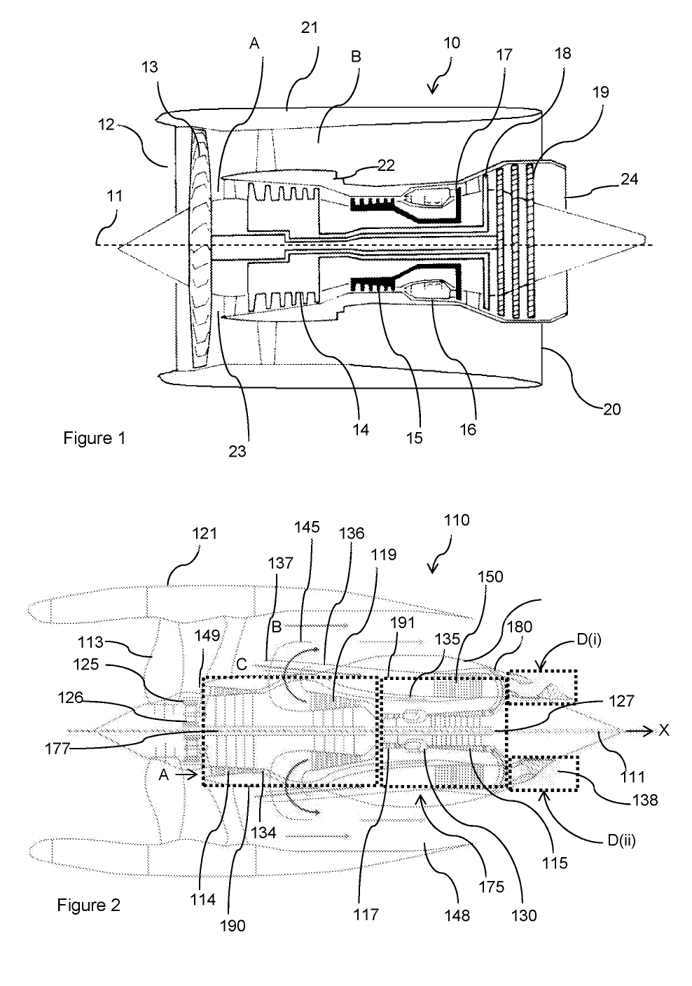

### DETAILED DESCRIPTION

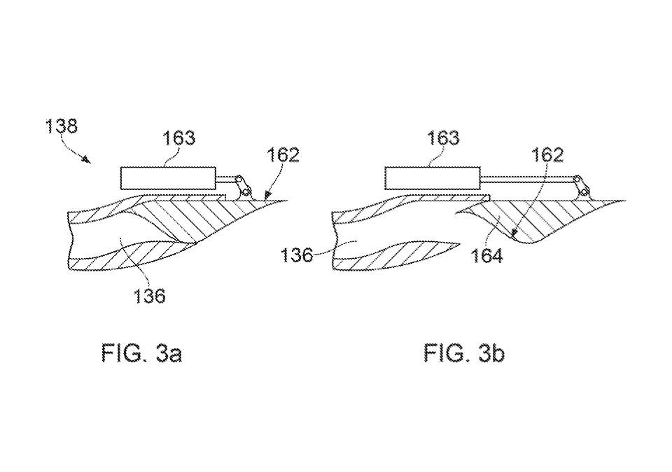

FIGS. 2 and 3 show a first gas turbine engine 110 in accordance with the present invention. The engine 110 comprises a ducted fan 113 provided within a fan nacelle 121 which defines a bypass passage 148. The fan 113 provides a propulsive air flow B which flows parallel to an axial direction X. A forward direction is defined by an axial direction anti-parallel to this direction.

The engine 110 further comprises an engine core 175. The core 175 comprises a first core module 190 comprising a first compressor in the form of a low pressure compressor 114 configured to draw core flow air A into the core 175 from an inlet 149 positioned downstream of the fan 113. The first core module 190 further comprises a first turbine in the form of a low pressure fan drive turbine 119 interconnected by a first shaft in the form of a low pressure shaft 177. The core 175 further comprises a second core module 191 comprising a second compressor in the form of a high pressure compressor 115 and a high pressure turbine 117 interconnected by a second shaft in the form of a high pressure shaft 127. The first and second modules 190, 191 are separated in an axial direction X, i.e. they do not overlap in the axial direction. In this embodiment, each component of the first module 190 is provided forwardly (i.e. in a direction opposite to the axial direction X) of each component of the second module 191. Consequently, though the shafts 127, 177 rotate about a common engine axis 111, the shafts do not overlap in an axial direction.

The core 175 defines a core airflow path A. The fan 113 is driven by the fan drive turbine 119 via a fan drive coupling. The fan drive coupling comprises an output shaft 125 which is coupled to the fan 113 via a reduction gearbox 126. The gearbox 126 is driven by the fan drive shaft 177, and is configured to drive the output shaft, and so the fan, at a lower rotational speed than the input shaft 177. The gearbox 126 provides a reduction ratio, such that the ratio between the input shaft 177 rotational speed and the fan 113 rotational speed is approximately 4:1. The gearbox 126 may comprise further toothed gear wheels, and may comprise a planetary or star gearbox configuration. Alternatively, the gearbox may comprise a differential drive, or a continuously variable transmission or belt drive.

Both the compressors 114, 115 generally comprise multi-stage axial flow compressors. At a rearward end of the low pressure compressor 114 is a low pressure compressor outlet 134. Air from the low pressure compressor 114 is directed in operation to the low pressure compressor outlet 134, into an inter-compressor core air duct 135. The inter-compressor core air duct 135 extends rearwardly toward a rear end of the gas turbine engine core 175. Surrounding at least part of the inter-compressor core air duct 135 is an intercooler fan air duct 136. The intercooler fan air duct 136 comprises a hollow passage having an inlet 137 at a forward end configured to ingest fan air from within the fan nacelle 121, downstream of the fan 113, to define an intercooler airflow C.

A heat exchanger matrix 150 is provided at an aft end of the intercooler fan air duct 136 and inter-compressor core air duct 135. Air from the ducts 135, 136 is in thermal contact within the heat exchanger matrix. In view of the temperature difference between the high temperature compressed airflow A within the inter-compressor duct 135 and low temperature intercooler airflow C within the intercooler duct 137, heat is exchanged from the compressed airflow A to the intercooler airflow C. Consequently, the intercooler duct 136 and inter-compressor core air duct 135 together form a compressor intercooler 150, thereby reducing the work required by further compressor stages, and increasing thermal efficiency.

The intercooler duct 136 further comprises an intercooler cooling flow modulation valve 138 configured to modulate intercooler airflow C mass flow rate. FIGS. 3a and 3b show a cross section of the region D(i) and D(ii) of FIG. 2 respectively. It will be understood that the positions shown in the top and bottom half of FIG. 2 are for illustrative purposes, and in practice, the flow modulate valve is likely to be in the same position at all engine circumferential positions.

In FIGS. 3a and 3b, the valve 138 is shown in a closed and an open position respectively. As can be seen, the flow modulation valve 138 comprises an axially movable exhaust plug 162, which is moveable between a closed position (shown in FIG. 3a) and an open position (shown in FIG. 3b) by a valve actuator 163 in the form of a hydraulic ram. As will be understood, the plug 162 may be moveable to intermediate positions between the open and closed positions. When in the open position, the airflow C mass flow rate is relatively high, resulting in a large amount of compressor air intercooling. On the other hand, when in the closed position, the airflow C mass flow rate is relatively low, or is shut off completely, such that little or no compressor air intercooling is provided. Consequently, the degree of intercooling can be controlled.

The exhaust plug 162 is shaped such that, when in the closed position, the intercooler duct 136 and plug 162 form a continuous surface, which tapers in a rearward direction in a “boat tail” configuration. Consequently, the intercooler duct 136 and plug 162 provide minimal drag when in the closed position. Similarly, a front surface 164 is angled downwardly, such that the plug provides minimal drag when in the open position. The shape of the plug 162 may be such that it uses the Coanda effect to redirect airflow C back towards a rearward direction.

The inter-compressor duct 135 comprises an elbow 180 at a rearward, downstream in core flow A end, which redirects core flow A at the downstream end by substantially 180° to a forward direction. The core flow A is thereby directed in operation into an inlet of the high pressure compressor 115. In operation, the high pressure compressor 115 further raises the pressure of the core air flow A in operation, and urge the core air flow A forwardly.

Axially forwardly (i.e. downstream in core flow A) of the high pressure compressor 115 is the combustor 130, which is of conventional construction. In the combustor 130, fuel is provided and burnt with the compressed air from the high pressure compressor 115 in operation to increase the temperature of the core air flow A.

The high pressure turbine 117 is provided axially forwardly (i.e. downstream in core flow A) of the combustor 130. In use, the high pressure turbine 117 directs flow forwardly, while extracting energy from the flow to drive the high pressure shaft 127, which is coupled to the high pressure compressor 115, to thereby drive the high pressure compressor 115 in operation.

Axially forwardly (i.e. downstream in core flow A) of the high pressure turbine 117 is the low pressure fan drive turbine 119, which is of similar construction to the high pressure turbine 117, comprising a plurality of rotors and stators. The low pressure fan drive turbine 119 is coupled to both the low pressure compressor 114 and the gearbox 126. Consequently, the low pressure turbine 119 drives the fans 113 and the low pressure compressor 114 via the shaft 177 in operation.

Between the low pressure turbine 119 and the low pressure compressor 114 is a core exhaust passage 145, which is configured to receive hot combustion products from a downstream end of the low pressure fan drive turbine 119 in the core air flow A. The core exhaust passage 145 turns core air flow A approximately 180°, and so redirects air rearwardly in use. Core air A from the core exhaust passage 145 mixes with fan air B downstream within the nacelle 121.

Consequently, the above arrangement defines a “reverse flow” architecture, in which core flow A flows in a forward direction during at least part of the compression and expansion processes, i.e. in an opposite direction to the fan efflux, since at least one core turbine 117, 119 is provided forwardly of at least one core compressor.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, the fans could comprise variable pitch blades. In such a case, a cold flow thrust reverse mechanism may be provided.

The first and second shafts need not be co-axial, and could be offset relative to one another.

A plurality of fans could be provided, each being driven by the fan drive turbine. A recuperator could be provided, configured to exchange heat from relatively high temperature exhaust air downstream of the fan drive turbine, and relatively low pressure compressed core air downstream of the high pressure compressor.

1. An aircraft gas turbine engine comprising:
a fan arranged to be driven by a gas turbine engine core, the core comprising a first core module comprising a first compressor and a first turbine interconnected by a first shaft, and a second core module comprising a second compressor and a fan drive turbine interconnected by a second shaft, the first and second core modules being axially spaced;
an intercooler arrangement configured to cool core airflow between the first and second compressors, the intercooler arrangement comprising a cooling air duct provided in heat exchange relationship with a compressor duct provided between the first and second compressors, the cooling air duct comprising a fan air inlet configured to ingest fan air, downstream of the fan, wherein the cooling air duct comprises a flow modulation valve configured to modulate air mass flow through the fan air inlet.

2. A gas turbine engine according to claim 1, wherein the core comprises a compressor provided axially rearwardly of the fan drive turbine.

3. A gas turbine engine according to claim 1, wherein the fan drive coupling comprises a gearbox arranged such that the fan drive turbine rotates at a higher rotational speed than the fan in use.

4. A gas turbine engine according to claim 3, wherein the gearbox has an input:output ratio of between 1 and 5.

5. A gas turbine engine according to claim 1 wherein the second core compressor comprises a low pressure compressor coupled to the fan drive turbine by a low pressure shaft.

6. A gas turbine engine according to claim 1, wherein the gas turbine engine comprises an exhaust duct configured to redirect forward flowing exhaust air from the fan drive turbine to a rearward direction.

7. An aircraft comprising a gas turbine engine in accordance with claim 1.
